(19) United States
(12) Patent Application Publication
(10) Pub. No.: US 2012/0128235 A1
(43) Pub. Date: May 24, 2012

(54) APPARATUS AND METHOD FOR RECONSTRUCTING COMPUTED TOMOGRAPHY IMAGE USING COLOR CHANNEL OF GRAPHIC PROCESSING UNIT

(75) Inventors: Jeong Won LEE, Daejeon (KR); Byeong Hun LEE, Seoul (KR); Soo Yeul LEE, Daejeon (KR)

(73) Assignee: Electronics and Telecommunication Research Institute, Daejeon (KR)

(21) Appl. No.: 13/294,745

(22) Filed: Nov. 11, 2011

(30) Foreign Application Priority Data
Nov. 23, 2010 (KR) 10-2010-0116740

(51) Int. Cl. G06K 9/00

(52) U.S. Cl. 382/154

(57) ABSTRACT

Provided is an apparatus and method for reconstructing a computed tomography (CT) image using a color channel of a graphic processing unit (GPU) that reconstructs a three-dimensional (3D) image using a projection image obtained from a CT device. According to an embodiment of the present invention, an apparatus for reconstructing a CT image may include a tomography unit to acquire a plurality of projection images, a filter application unit to load the plurality of projection images on a texture memory having a color channel, and filter the plurality of projection images, and a back-projection application unit to apply a back-projection scheme to the plurality of projection images loaded on the texture memory having a color channel.

### CROSS-REFERENCE TO RELATED APPLICATION

This application claims the benefit of Korean Patent Application No. 10-2010-0116740, filed on Nov. 23, 2010, in the Korean Intellectual Property Office, the disclosure of which is incorporated herein by reference.

### BACKGROUND

1. Field of the Invention

The present invention relates to an apparatus and method for reconstructing a computed tomography (CT) image using a color channel of a graphic processing unit (GPU) that reconstructs a three-dimensional (3D) image using a projection image obtained from a CT device.

2. Description of the Related Art

Filtered back-projection (FBP) is a scheme of reconstructing three-dimensional (3D) volume data with a projection image after processing a projection filter to eliminate blurring of back-projection data.

FBP may include a filtering operation for removing noise from a projection image and a back-projection operation for recording a value in a 3D volume dataset, and the filtering operation and the back-projection operation may be performed independently.

The filtering operation may perform input a single projection image and filter the single projection image. The back-projection operation may record a value in a 3D volume dataset allocated in a memory, with reference to a value in a single projection image.

Multiple projection images may be independently filtered in the filtering operation and multiple filtered projection images may be independently back-projected in the back-projection operation.

Thus, FBP is being widely used in CT devices due to a fast process and a construction of an image similar to a subject. Accordingly, a scheme of processing a projection image may be used to enhance a processing speed of FBP.

### SUMMARY

An aspect of the present invention provides an apparatus and method for reconstructing a computed tomography (CT) image using a color channel of a graphic processing unit (GPU) that may reduce calculating time by loading a plurality of projection images on a texture memory having a GPU with red, green, blue, and alpha (RGBA) color channels and concurrently filtering the plurality of projection images when reconstructing three-dimensional (3D) data using a projection image.

Another aspect of the present invention also provides an apparatus and method for reconstructing a CT image using a color channel of a GPU that may concurrently back-project multiple filtered projection images and update the projection images in a process of back-projecting a filtered projection-image.

Still another aspect of the present invention also provides an apparatus and method for reconstructing a CT image using a color channel of a GPU that may reduce calculating time by loading four projection images on a memory having RGBA color channels, respectively, and concurrently filtering the four projection images loaded on the memory.

Yet another aspect of the present invention also provides an apparatus and method for reconstructing a CT image using a color channel of a GPU that may store, in a register, a back-projection value obtained from a plurality of filtered projection images and record the back-projection value in a 3D volume dataset in an ending operation.

According to an aspect of the present invention, there is provided an apparatus for reconstructing a CT image using a color channel of a GPU, the apparatus including a tomography unit to acquire a plurality of projection images, a filter application unit to load the plurality of projection images on a texture memory having a color channel, and filter the plurality of projection images, and a back-projection application unit to apply a back-projection scheme to the plurality of projection images loaded on the texture memory.

The filter application unit may load the plurality of projection images on a texture memory having RGBA color channels, and concurrently filter the plurality of projection images using single instruction multiple data (SIMD).

The back-projection application unit may record a back-projection value in a 3D volume dataset, with reference to the plurality of filtered projection images loaded on the texture memory.

The back-projection application unit may store, in a register, a back-projection value obtained from the plurality of projection images and record the back-projection value in a 3D volume dataset.

The back-projection application unit may update a back-projection value corresponding to the plurality of filtered projection images.

The apparatus may further include an image acquisition unit to acquire a CT image by applying the back-projection scheme to the plurality of projection images loaded on the texture memory.

The tomography unit may acquire the plurality of projection images corresponding to a number of color channels, and the filter application unit may load the plurality of projection images corresponding to a number of color channels on a texture memory, and filter the plurality of projection images.

According to an aspect of the present invention, there is provided a method of reconstructing a CT image using a color channel of a GPU, the method including acquiring a plurality of projection images, loading the plurality of projection images on a texture memory having a plurality of color channels, and filtering the plurality of projection images, and applying a back-projection scheme to the plurality of projection images loaded on the texture memory.

The loading and filtering may include loading the plurality of projection images on a texture memory having color channels of RGBA, and concurrently filtering the plurality of projection images using SIMD.

The applying may include recording a back-projection value in a 3D volume dataset, in reference to the plurality of filtered projection images loaded on the texture memory.

The applying may include storing, in a register, a back-projection value obtained from the plurality of projection images and recording the back-projection value in a 3D volume dataset.

The applying may include updating a back-projection value corresponding to the plurality of filtered projection images.

The method may further include acquiring a CT image by applying the back-projection scheme to the plurality of projection images loaded on the texture memory.

The acquiring may include acquiring the plurality of projection images corresponding to a number of color channels, and the applying may include loading the plurality of projection images corresponding to a number of color channels on the texture memory, and filtering the plurality of projection images.

According to an aspect of the present invention, it is possible to reduce calculating time by loading a plurality of projection images on a texture memory having color channels of the GPU and concurrently filtering the plurality of projection images when reconstructing 3D data using a projection image, and complete an image processing to output a CT image within a relatively short period of time.

According to an aspect of the present invention, it is possible to concurrently back-project multiple filtered projection images and update the projection images, in a process of back-projecting a filtered projection-image, thereby reducing time for processing an image to output a CT image within a relatively short period of time.

According to an aspect of the present invention, it is possible to reduce calculating time by loading four projection images on a memory having RGBA color channels, respectively, and concurrently filtering the four projection images loaded on the memory, thereby completing and outputting a CT image within a relatively short period of time.

According to an aspect of the present invention, it is possible to store, in a register, a back-projection value obtained from a plurality of filtered projection images and record the back-projection value in a 3D volume dataset at a last operation, thereby acquiring a CT image.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a diagram illustrating an operation of loading a projection image on a texture memory having color channels of red, green, blue, and alpha (RGBA) and filtering the projection image according to an embodiment of the present invention;

FIG. 2 is a diagram illustrating a configuration of a computed tomography (CT) imager according to an embodiment of the present invention; and

FIG. 3 is a flowchart illustrating a method of reconstructing a CT image according to an embodiment of the present invention.

### DETAILED DESCRIPTION

Reference will now be made in detail to exemplary embodiments of the present invention, examples of which are illustrated in the accompanying drawings, wherein like reference numerals refer to the like elements throughout. Exemplary embodiments are described below to explain the present invention by referring to the figures.

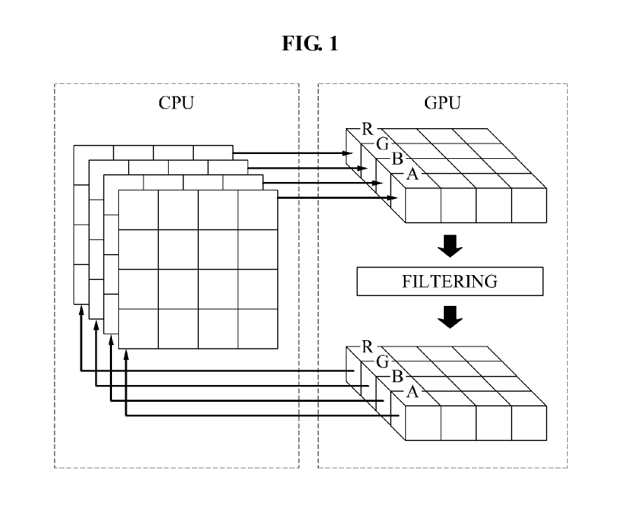

FIG. 1 is a diagram illustrating an operation of loading a projection image on a texture memory having color channels of red, green, blue, and alpha (RGBA) and filtering the projection image according to an embodiment of the present invention.

A computed tomography (CT) imager may acquire a plurality of projection images by taking images of an object from multiple angles using x-rays. The CT imager may load the plurality of projection images on a memory.

The CT imager may load, on a texture memory having a graphic processing unit (GPU) with RGBA color channels, the plurality of projection images loaded on a memory of a central processing unit (CPU), and filter the plurality of projection images. The CT imager may load four projection images on a texture memory having RGBA color channels, and concurrently filter the four projection images. The CT imager may load, on a texture memory having RGBA color channels, projection images corresponding to a number of color channels of a GPU, and concurrently filter a plurality of projection images corresponding to the number of color channels while the projection images are loaded on the texture memory.

The CT imager may record a back-projection value in a three-dimensional (3D) volume dataset with reference to a plurality of filtered projection images. That is, the CT imager may store, in a register, a back-projection value obtained from a plurality of filtered projection images and record the back-projection value in a 3D volume dataset in an ending last operation. The CT imager may acquire a CT image by recording, in a 3D volume dataset, a back-projection value obtained by applying a back-projection scheme to a plurality of filtered projection images.

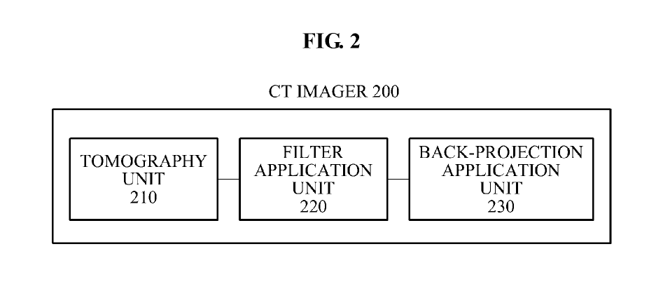

FIG. 2 is a diagram illustrating an internal configuration of a computed tomography (CT) imager 200 according to an embodiment of the present invention.

Referring to FIG. 2, the CT imager 200 according to an embodiment of the present invention may include a tomography unit 210, a filter application unit 220, and a back-projection application unit 230.

The tomography unit 210 may acquire a plurality of projection images by taking images of an object from multiple angles using x-rays. The tomography unit 210 may acquire a plurality of projection images by taking images of an object from multiple angles through control of an x-ray generator and an x-ray detector, and provide the plurality of acquired projection images to the filter application unit 220. The tomography unit 210 may store, in a memory of a central processing unit (CPU), a plurality of projection images corresponding to a number of color channels of a GPU so as to enhance efficiency of a filter.

The filter application unit 220 may load, on a texture memory of the GPU having RGBA color channels, the plurality of projection images stored in the CPU, and filter the plurality of projection images. The filter application unit 220 may concurrently filter four projection images loaded on the texture memory having color channels of RGBA of the GPU. That is, the filter application unit 220 may load four projection images on a texture memory having RGBA color channels and concurrently filter the four projection images using single instruction multiple data (SIMD). Here, the filter application unit 220 may correct noise contained in a projection image through filtering. The filter application unit 220 may provide the back-projection application unit 230 with the projection image in which noise is eliminated through filtering.

The back-projection application unit 230 may apply a back-projection scheme to the plurality of projection images loaded on the texture memory having RGBA color channels. The back-projection application unit 230 may record a back-projection value in a 3D volume dataset allocated in a memory, in reference to a value from a single projection image by applying a back-projection scheme to the plurality of projection images. The back-projection application unit 230 may acquire a CT image by recording, in a 3D volume dataset, a back-projection value obtained by applying the back-projection scheme to the plurality of projection images.

The back-projection application unit 230 may record a back-projection value in a 3D volume dataset, in reference to the plurality of filtered projection images loaded on the texture memory. The back-projection application unit 230 may record a back-projection value in a 3D volume dataset, in reference to a projection image while the plurality of projection images is loaded on the texture memory. The back-projection application unit 230 may configure a CT image by recording a back-projection value in a 3D volume dataset.

The back-projection application unit 230 may store, in a register, a back-projection value obtained from a plurality of filtered projection images and record, in a 3D volume dataset, the back-projection value stored in the register in an ending of processing a CT image. The back-projection application unit 230 may acquire a CT image by concurrently updating back-projection values recorded in the 3D volume dataset corresponding to the plurality of filtered projection images.

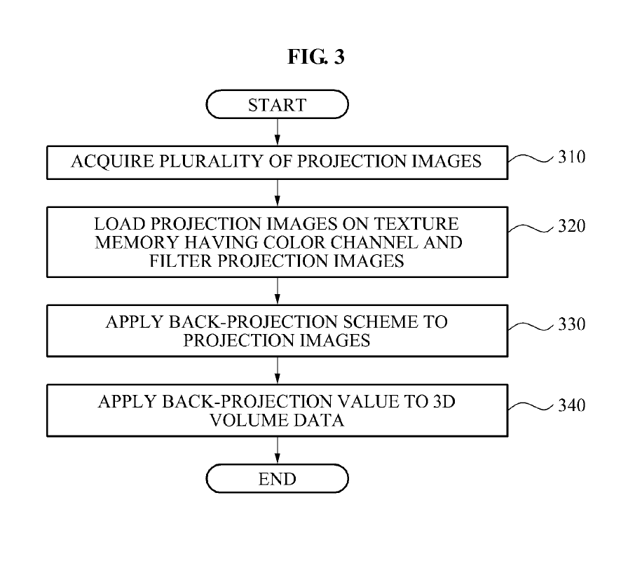

FIG. 3 is a flowchart illustrating a method of reconstructing a CT image according to an embodiment of the present invention.

The method of reconstructing a CT image according to an embodiment of the present invention may be embodied by the CT imager illustrated in FIG. 2. Hereinafter, the present invention will be understood through descriptions of FIG. 3 with reference to FIG. 2.

In operation 310, the CT imager may acquire a plurality of projection images by taking images of an object from multiple angles using x-rays. The CT imager may acquire a plurality of projection images by taking images of an object from multiple angles through control of an x-ray generator and an x-ray detector, and store the plurality of acquired projection images in a memory of a CPU. The CT imager may store, in a memory, a plurality of projection images corresponding to a number of color channels of a GPU.

In operation 320, the CT imager may load, on a texture memory of the GPU having RGBA color channels, the plurality of projection images stored in the CPU, and filter the plurality of projection images. Here, the CT imager may concurrently filter four projection images loaded on the texture memory having color channels of RGBA of the GPU. The CT imager may load four projection images on a texture memory having RGBA color channels, and concurrently filter the four projection images using SIMD. The CT imager may eliminate noise contained in a projection image through filtering. That is, the CT imager may use a memory having a color channel for applying a back-projection scheme to the projection image in which noise is eliminated.

In operation 330, the CT imager may apply a back-projection scheme to the plurality of projection images loaded on the texture memory having RGBA color channels. Here, she CT imager may record a back-projection value in a 3D volume dataset allocated in a memory, with reference to a value from a single projection image by applying a back-projection scheme to the plurality of projection images. That is, the CT imager may acquire a back-projection value by applying a back-projection scheme to a filtered projection image, and record the acquired back-projection value in a 3D volume dataset.

In operation 340, the CT imager may record a back-projection value in a 3D volume dataset, with reference to the plurality of filtered projection images loaded on the memory. The CT imager may record a back-projection value in a 3D volume dataset, with reference to a projection image while the plurality of projection images is loaded on the memory.

The CT imager may store, in a register, a back-projection value obtained from a plurality of filtered projection images and record, in a 3D volume dataset, the back-projection value stored in the register in an ending operation of processing a CT image. The CT imager may concurrently update back-projection values in correspondence to the plurality of filtered projection images.

The above-described exemplary embodiments of the present invention may be recorded in non-transitory computer-readable media including program instructions to implement various operations embodied by a computer. The media may also include, alone or in combination with the program instructions, data files, data structures, and the like. Examples of non-transitory computer-readable media include magnetic media such as hard disks, floppy disks, and magnetic tape; optical media such as CD ROM discs and DVDs; magneto-optical media such as optical discs; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described exemplary embodiments of the present invention, or vice versa.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. An apparatus for reconstructing a computed tomography (CT) image using a color channel of a graphic processing unit (GPU), the apparatus comprising:
a tomography unit to acquire a plurality of projection images;
a filter application unit to load the plurality of projection images on a texture memory having a color channel, and filter the plurality of projection images; and
a back-projection application unit to apply a back-projection scheme to the plurality of projection images loaded on the texture memory.

2. The apparatus of claim 1, wherein the filter application unit loads the plurality of projection images on the texture memory having red, green, blue, and alpha (RGBA) color channels, and concurrently filters the plurality of projection images using single instruction multiple data (SIMD).

3. The apparatus of claim 1, wherein the back-projection application unit records a back-projection value in a three-dimensional (3D) volume dataset, with reference to the plurality of filtered projection images loaded on the texture memory.

4. The apparatus of claim 1, wherein the back-projection application unit stores, in a register, a back-projection value obtained from the plurality of projection images and records the back-projection value in a 3D volume dataset.

5. The apparatus of claim 1, wherein the back-projection application unit updates a back-projection value corresponding to the plurality of filtered projection images.

6. The apparatus of claim 1, further comprising:
an image acquisition unit to acquire a CT image by applying the back-projection scheme to the plurality of projection images loaded on the texture memory.

7. The apparatus of claim 1, wherein:
the tomography unit acquires the plurality of projection images corresponding to a number of color channels, and
the filter application unit loads the plurality of projection images corresponding to a number of color channels on the texture memory, and filters the plurality of projection images.

8. A method of reconstructing a computed tomography (CT) image using a color channel of a graphic processing unit (GPU), the method comprising:
acquiring a plurality of projection images;
loading the plurality of projection images on a texture memory having a plurality of color channels, and filtering the plurality of projection images; and
applying a back-projection scheme to the plurality of projection images loaded on the texture memory.

9. The method of claim 8, wherein the loading and filtering comprises loading the plurality of projection images on the texture memory having red, green, blue, and alpha (RGBA) color channels, and concurrently filtering the plurality of projection images using single instruction multiple data (SIMD).

10. The method of claim 8, wherein the applying comprises recording a back-projection value in a three-dimensional (3D) volume dataset, with reference to the plurality of filtered projection images loaded on the texture memory.

11. The method of claim 8, wherein the applying comprises storing, in a register, a back-projection value obtained from the plurality of projection images and recording the back-projection value in a 3D volume dataset.

12. The method of claim 8, wherein the applying comprises updating a back-projection value corresponding to the plurality of filtered projection images.

13. The method of claim 8, further comprising:
acquiring a CT image by applying the back-projection scheme to the plurality of projection images loaded on the texture memory.

14. The method of claim 8, wherein:
the acquiring comprises acquiring the plurality of projection images corresponding to a number of color channels, and
the applying comprises loading the plurality of projection images corresponding to a number of color channels on the texture memory, and filtering the plurality of projection images.
